(19) United States
(12) Patent Application Publication
(10) Pub. No.: US 2011/0014338 A1
(43) Pub. Date: Jan. 20, 2011

(54) MACHINE FOR PREPARING HOT BEVERAGES AND METHOD FOR OPERATING SUCH A MACHINE

(75) Inventor: ACHIM CLOER, Arnsberg (DE)

Correspondence Address: HENRY M FEIEREISEN, LLC;HENRY M FEIEREISEN, 708 THIRD AVENUE, SUITE 1501, NEW YORK, NY, 10017, US

(73) Assignee: Caspar Cloer GmbH & Co. KG, Arnsberg (DE)

(21) Appl. No.: 12/835,272

(22) Filed: Jul. 13, 2010

Related U.S. Application Data
(60) Provisional application No. 61/241,571, filed on Sep. 11, 2009.

(30) Foreign Application Priority Data
Jul. 14, 2009 (DE) 10 2009 033 253.7

(51) Int. Cl. A47J 31/44; A47J 31/46; A23F 5/26

(52) U.S. Cl. 426/433; 99/288; 99/300

(57) ABSTRACT

A machine for preparing a hot beverage includes a water tank having a reservoir which contains water to be heated. Disposed downstream of the reservoir in a flow direction of the water is a lead container from which water is discharged into a pipe which is heated by a heating unit, thereby partly evaporating water to produce steam for further transport of water. In order to maintain a constant brew temperature, the water level is maintained in the lead container at a desired value.

### CROSS-REFERENCES TO RELATED APPLICATIONS

This application claims the benefit of prior filed U.S. provisional Application No. 61/241,571, filed Sep. 11, 2009, pursuant to 35 U.S.C. 119(e).

This application claims the priority of German Patent Application, Serial No. 10 2009 033 253.7, filed Jul. 14, 2009, pursuant to 35 U.S.C. 119(a)-(d).

The contents of U.S. provisional Application No. 61/241,571 and German Patent Application, Serial No. 10 2009 033 253.7 are incorporated herein by reference in their entirety as if fully set forth herein.

### BACKGROUND OF THE INVENTION

The present invention relates to a machine for preparing hot beverages and to a method for operating such a machine.

The following discussion of related art is provided to assist the reader in understanding the advantages of the invention, and is not to be construed as an admission that this related art is prior art to this invention.

Machines for semiautomatic preparation of hot beverages, especially coffee, are equipped with a water tank from which water automatically runs into a heating unit. The heating unit includes pipes through which water flows. A non-return valve prevents a backflow of water. As an alternative, the pipelines and the minimum water level can also be so dimensioned as to eliminate the need for a non-return valve. Water heats up and forms steam bubbles. Pressure builds up, thereby closing the non-return valve. Water is propelled upwards via a riser pipe as a consequence of the forming pressure and flows into a filter in which coffee is brewed.

As the water level drops in the water tank, the hydrostatic pressure that acts on the heating unit also drops. As a result, the volume flow which enters the heating unit through the non-return valve changes as well.

The volume flow may be throttled by a smaller cross section of the pipeline. Such throttling is also possible through a constriction (throttle insert) in the pipeline system. The reduction effect is primarily effectuated by the length of this constriction in addition to the diameter. Also a non-return valve, disposed in the pipeline system, contributes to the throttling of the volume flow. On the other hand, the volume flow is also dependent on the hydrostatic pressure.

When the cross section of the feed line to the pipes in the heating unit is selected too small, there is the problem that too little water is able to reach the heating unit when the water level drops so that the water is excessively heated. As a result, too much steam is generated and too little water reaches the filter. In the event, the cross section of the feed line is selected too large, too much water flows into the heating unit. Water is then inadequately heated so that coffee is brewed insufficiently and remains overall too cold. A lower brew temperature also adversely affects the taste of the coffee.

It is best for the coffee taste when brewing is implemented at the same temperature throughout the entire brewing process. Taste is altered already at a change of few degrees. Besides the increase in temperature, it is therefore also desired to stabilize the temperature throughout the entire brewing process.

When seeking a continuous volume flow and thus a continuously constant heating of the water, it is theoretically necessary to suit the cross section and/or the length of the feed line to the heating unit or the cross section and/or the length of a throttle insert upstream of the heating unit to the inevitably dropping water level and the resultant hydrostatic pressure. A very sensitive change of the pipe cross section may, however, be realized only with adjustable throttle inserts and in a very complicated manner, a fact that makes economically no sense when mass products like coffee machines are involved.

It would therefore be desirable and advantageous to provide an improved machine and method for preparing hot beverages to obviate prior art shortcomings and to simplify the overall construction while realizing a high temperature which is as constant as possible during brew time with water, in particular when brewing coffee or tee is involved.

### SUMMARY OF THE INVENTION

According to one aspect of the present invention, a machine for preparing a hot beverage includes a water tank having a reservoir containing water to be heated, and a lead container disposed downstream of the reservoir in a flow direction of the water, a pipe receiving water from the lead container, a heating unit heating the pipe, thereby partly evaporating water to produce steam for further transport of water, and control means for maintaining a water level at a desired value in the lead container and thus at a stable level.

The water level may hereby fluctuate slightly about the desired value. This fluctuation is however significantly less compared to a water tank with dropping water level from a maximum value at the start of the brewing process to a complete emptying at the end of the brewing process. As the water level remains the same, the hydrostatic pressure also remains constant. As a result of the constant pressure, a constant volume flow passes through the heating unit. A feed line to the heating unit or a throttle insert to define a constriction can thus be provided in order to realize a controlled heating of water, without necessitating cumbersome modification of the pipe cross section. This leads to better brewing results and thus also to improvements in taste.

Since little water is in the riser pipe when the water level is low, less cold water is pressed out from the riser pipe at the start. As a result, at the start of the brewing process, the brewing product comes into contact with water that is at a higher temperature.

According to another advantageous feature of the present invention, the heating unit may be a flow heater. The contour of the hollow spaces through which fluid flows is hereby secondary. For example, in addition to long slight heated pipes that are in use frequently and are typically bent into the shape of a U or the shape of a horseshoe, the application of a short but thick pipe may be possible as well. Also possible is a heated deep-drawn cup through which water flows. In general, the term “pipe” when used in the context of a heating unit relates to any geometry of a heating chamber of the heating unit through which a fluid flows.

According to another advantageous feature of the present invention, the lead container may be connected to the atmosphere. In this way, a same atmospheric pressure prevails in the lead container as in the environment in which the machine operates. As a result, water is able to continue to flow unimpeded from the lead container. A simple pressure compensating line can be used to realize the pressure compensation to the atmosphere.

According to another advantageous feature of the present invention, the lead container can be positioned below the reservoir. An outlet port can be disposed between the reservoir and the lead container and can be suitably provided with a valve. This valve can control the supply of water from the reservoir into the lead container and thus the water level in the lead container and thence the hydrostatic pressure which is relevant for the volume flow.

The diameters of the pipes in the heating unit and the feed line to the heating unit are optimized for a particular volume flow. There is no need for a constant diameter and cross section over the entire length of the pipes and feed lines. It is possible to adjust the volume flow by using exchangeable throttle inserts in the feed line. The length and diameter of the throttle inserts is hereby suited such as to establish a particular/necessary volume flow.

According to another advantageous feature of the present invention, the throughflow can be changed, using in particular a flow control, to enable a final fine tuning. This allows compensation of tolerances of the radiator, tolerances of the applied mains voltage, and different starting temperatures of water.

As described above, the volume flow depends on the hydrostatic pressure. To realize a certain volume flow, a particular hydrostatic pressure is necessary which is established only at a certain desired value of the water level in the heating unit. When water flows from the lead container to the heating unit, the water level in the lead container drops so that the water level falls below the desired value. By regulating the supply from the reservoir into the lead container, the water level is raised again to the desired value. The water level is regulated, even when the water level drops only slightly. As a consequence, fluctuations of the optimum water level in the lead container are insignificant and the volume flow can be kept effectively constant.

The amount of water necessary for setting the desired value in the lead container ranges advantageously from 50 to 150 ml, corresponding to half a cup of coffee to a whole cup of coffee. Depending on the machine type, this volume may also be increased and amount up to 400 ml.

In the event a water filter is arranged between reservoir and lead container to improve water quality, the throughflow of water through the water filter drops as the water level drops in the reservoir. In order to be able to compensate this at the end of the brewing process, there has to be at least enough water in the lead container so that the brewing process ends only when the filtering process has also ended. Thus, two ore more cups can be provided as buffer in the lead container in case the water level drops faster in the lead container than water is able to flow through the water filter.

The valve which controls the supply of water from the reservoir into lead container may be constructed in the form of a valve controlled by a float. A closure element is coupled with the float of the valve and assumes the function of a valve body for closing the outlet port. The float follows the changing water level in the lead container and is coupled directly or indirectly with the closure element. The closure element clears the outlet port, when the water level drops so that water is able to flow from the reservoir into the lead container. The closure element closes the outlet port as soon as the water level reached its desired value in the lead container. The maximum hydrostatic pressure, i.e. the desired pressure in the lead container, has been reached.

Opening and closing of the valve takes place automatically and long enough for the reservoir to fully empty out.

Another construction may also be conceivable and effective in which the supply is not completely interrupted but rather only throttled. Although at the start the water level rises more than wanted, the construction is still effective because after start of the brewing process, water flows almost continuously to the heating unit. A complete closing is thus not necessarily required. The benefit of throttling resides in the significantly smaller structure. This can be of interest in particular when retrofitting existing machines.

In such a construction, the volume of the lead container can be selected very small. When the machine starts to brew, the water level drops quickly to the optimum level which is then kept constant. A complete closing would thus be necessary for such dimensioning only for the first two to three brew intervals.

In addition to a reservoir that communicates with the atmosphere, it is also possible to seal the reservoir, except for the lower outlet port, in a fluid-tight manner from the atmosphere. As a consequence, pressure below atmospheric forms in the reservoir when water flows out from the lower outlet port. If the pressure below atmospheric is not compensated by air flowing in from below, no further water is able to flow out. In other words, in the event the outlet port is positioned below or even with the water level, the atmospheric air pressure pushes onto the water surface of the lead container and thus from below upon water in the reservoir. The result is a state of equilibrium by which water is kept in the reservoir. Air is able to flow from below into the reservoir only when the water level in the lead container drops so that the pressure in the reservoir rises slightly and water flows in opposition to the atmospheric pressure into the lead container. The water level rises there until a state of equilibrium is established again. Water is then no longer able to continue to flow.

In this configuration, the reservoir thus has an outlet port which interacts with the water level in such a way that the outlet port is closed by water, when the water level reaches a desired value. The reservoir is hereby sealed in a fluid-tight manner, except for the outlet port, and thus not in communication with the atmosphere.

Instead of integrating the reservoir in the water tank, it is also possible in accordance with another advantageous feature of the present invention, to provide a receptacle for an exchangeable reservoir. This exchangeable reservoir may, for example, be a commercially available water bottle. In this way, it is possible to prepare a hot beverage with different waters, without requiring a transfer thereof beforehand.

The exchangeable reservoir or water bottle are arranged according to the afore-described principle in such a way that the outlet port or bottle opening is level with the desired water level of the lead container. As the water level drops in the lead container, a clearance is formed between the outlet port or bottle opening and the water level. Water is then able to flow from the reservoir or water bottle into the lead container until the water level has reached again the desired value. Thus, the desired substantially constant hydrostatic pressure is also realized.

The provision of an exchangeable reservoir has also the benefit that there is no need to fill the water tank with the coffee or tea pot.

In all embodiments, fine tuning of the temperature is determined by the water level in the lead container and thus by the disposition of the outlet port at a certain level. The provision of a receptacle with height-adjustment may hereby be conceivable for receiving the exchangeable reservoir or water bottle. The desired value for the water level can thus be increased or reduced.

According to another aspect of the present invention, a method of operating a machine for preparing a hot beverage includes the steps of transferring water from a lead container which forms part of a water tank and is positioned downstream of a reservoir which forms another part of the water tank and is fluidly connectable to the lead container, into a pipe which is heated by a heating unit to partly evaporate water and thereby produce steam by which water can be further transported, and maintaining a water level at a desired value in the lead container to maintain a brew temperature constant. Thus, the brew temperature can be set in dependence on the height of the receptacle.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1A is a schematic illustration of a first embodiment of a water tank for a coffee machine in accordance with the present invention in a state of desired water level;

FIG. 1B is a schematic illustration of the water tank of FIG. 1A in a state when the water level has dropped;

FIG. 2A is a schematic illustration of a second embodiment of a water tank for a coffee machine in accordance with the present invention in a state of desired water level;

FIG. 2B is a schematic illustration of the water tank of FIG. 2A in a state when the water level has dropped;

FIG. 3 is a graphical illustration of the temperature profile for the brew temperature with and without constant hydrostatic pressure in the water tank; and

FIG. 4 is a graphical illustration of the temperature profile as measured at a drip stop with and without constant hydrostatic pressure in the water tank.

### DETAILED DESCRIPTION OF PREFERRED EMBODIMENTS

Throughout all the figures, same or corresponding elements may generally be indicated by same reference numerals. These depicted embodiments are to be understood as illustrative of the invention and not as limiting in any way. It should also be understood that the figures are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

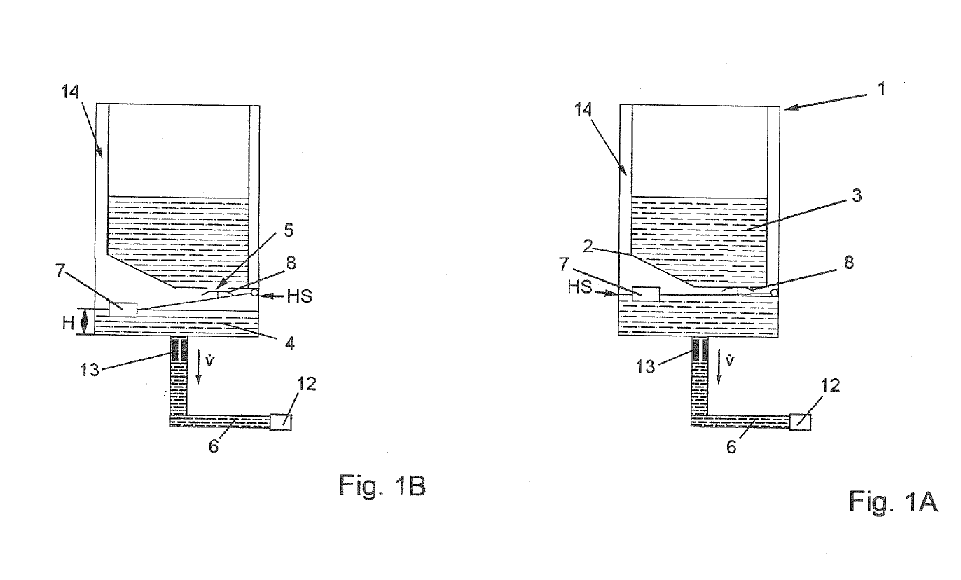

Turning now to the drawing, and in particular to FIG. 1A, there is shown a schematic illustration of a first embodiment of a water tank, generally designated by reference numeral 1, for a coffee machine in accordance with the present invention. The water tank 1 has a partition wall 2 to subdivide the water tank 1 into a reservoir 3 and a lead container 4. The reservoir 3 fluidly communicates with the lead container 4 via an outlet port 5 in the partition wall 2. The lead container 4 is connected with a pipe of a heating unit 12 via a connection line 6 with integrated insert 13 to define a constriction.

The lead container 4 includes an opening 14 for fluid communication with the surroundings to thereby effect a same atmospheric pressure in the lead container 4 as in the environment in which the machine operates.

A valve is disposed in the outlet port 5 to control a supply of water from the reservoir 3 to the lead container 4. In the shown non-limiting example of FIG. 1A, the valve is constructed as float-controlled valve which includes a float 7 and a closure element 8. This closure element 8 is provided to close the outlet port 5 in the partition wall 2 as soon as a water level H has reached a desired value HS. The float-controlled valve assumes the function to ensure that the water level H in the lead container 4 is able to fluctuate only slightly about a desired value HS.

A drop in the water level H in the lead container 4 causes the float 7 of the float-controlled valve to move away from the outlet port 5. As a result, the closure element 8 coupled with the float 7 clears the outlet port 5 so that water is able to flow from the reservoir 3 into the lead container 4, as shown in FIG. 1B. The water level H rises, causing the float 7 to rise as well so that the outlet port 5 is closed again by the closure element 8, when the water level H reaches the desired value HS (FIG. 1A).

The float 7 is advantageously dimensioned in such a way that only part thereof is required to dip in the water to build enough force to close the outlet port 5. The remaining lifting force is kept as reserve in order to be able to further increase the closing force in the event the valve leaks as a result of contamination or calcification for example. Making the closure element 8 of soft material enables compensation of small leaks with enhanced closing force.

The lead container 4 is subjected to a constant hydrostatic pressure. The volume flow \dot{V} flowing out of the lead container 4 into the heating unit 12 thus remains substantially constant. Water can thus be heated to the substantially same temperature at varying water level H of the reservoir 3 so that coffee or tea can be evenly brewed in a sufficiently hot manner.

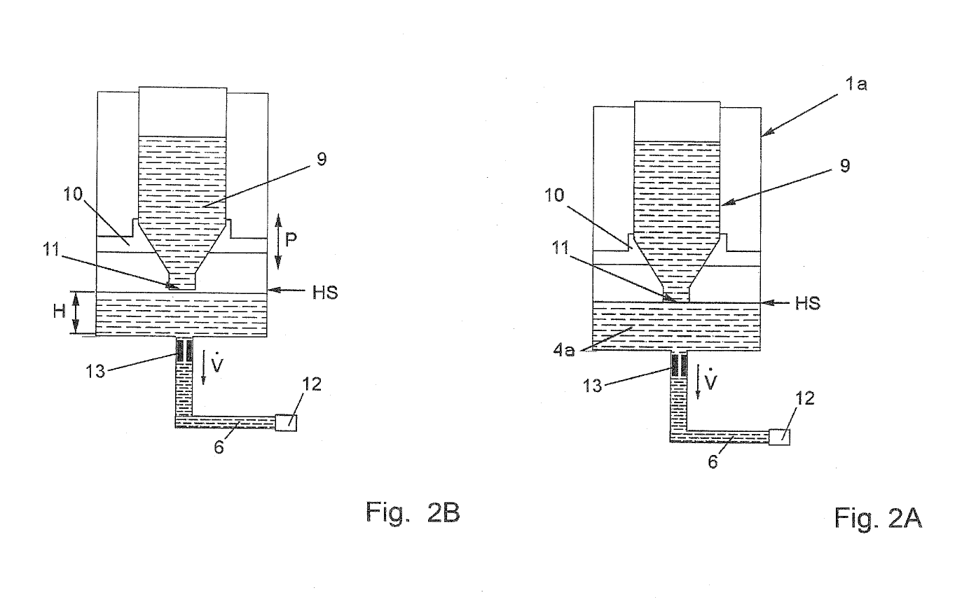

FIGS. 2A and 2B show schematic illustrations of a second embodiment of a water tank, generally designated by reference numeral 1a, for a coffee machine in accordance with the present invention. In the following description, parts corresponding with those in FIG. 1A will be identified, where appropriate for the understanding of the invention, by corresponding reference numerals followed by an “a”. In this embodiment, the water tank 1a has a reservoir 9 in the form of a water bottle disposed upside down and involving any commercially available design. Receptacles 10 are arranged for the reservoir 9 or water bottle in the water tank 1a and vertically adjustable in the direction of arrow P so that the water bottle 9 can be positioned in relation to the lead container 4a. The water bottle 9 is disposed in relation to the lead container 4a in such a manner that the outlet port 11 is substantially level with the desired value HS for the required water level H. When the water level H corresponds to the desired vale HS, the outlet port 11 is closed by water. Dropping of the water level H causes a clearing of the outlet port 11 so that water is able to flow from the water bottle 9 into the lead container 4a. As a consequence, the hydrostatic pressure and at the same time the dependent volume flow \dot{V} through the heating unit 12 is subject to only slight fluctuations. Water can thus be heated evenly.

The desired value HS for the water level H can be adjusted through upward or downward displacement of the receptacles 10. This changes the static pressure at the throttle insert 13 or in the connection line and thus the volume flow and as a result also the brew temperature. The throttle insert 13 may be exchangeably secured and/or secured for change in position in the flow path between lead container 4, 4a and the heating unit 12 for changing the volume flow \dot{V}. Furthermore, the throttle insert 13 may include means for changing the volume flow \dot{V} by which the cross section or the length of the flow path can be changed.

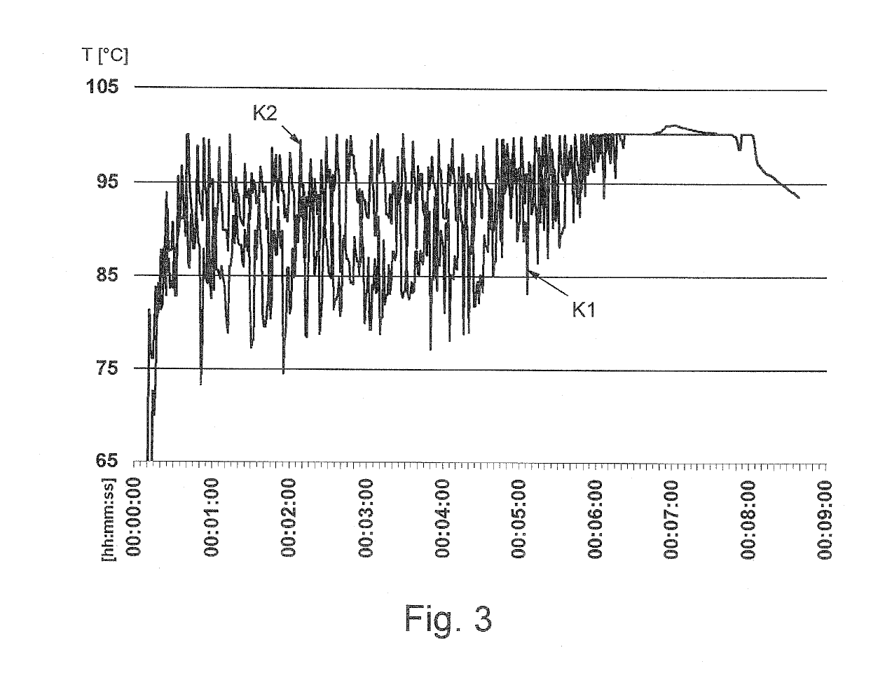

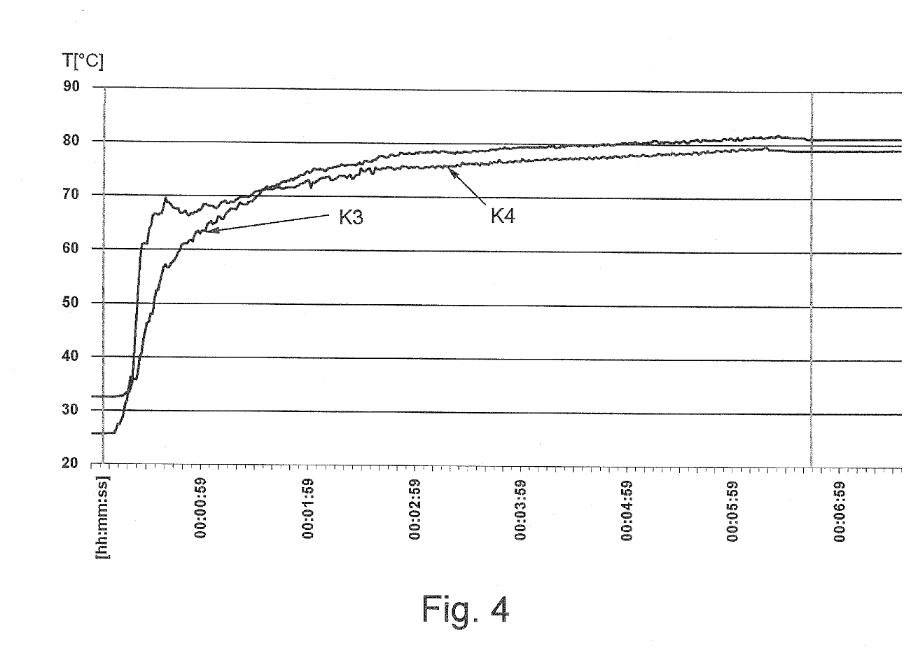

The differences in the temperature profiles between the coffee machine according to the invention and a standard coffee machine are illustrated in FIGS. 3 and 4.

FIG. 3 shows the measured temperature profiles as a function of time for the brew temperature of coffee. The time scale is given in minutes. The temperature is measured at a location where heated water exits the riser pipe in a filter. Curve K1 depicts the measured temperature profile for heating water when the hydrostatic pressure drops continuously. Curve K2 depicts the measured temperature profile for heating water when the hydrostatic pressure is substantially constant.

As can be clearly seen, water as a function of the hydrostatic pressure reaches the brew temperature only in the last quarter of curve K1. In other words, too much water flows through the heating unit at the beginning and is not adequately heated. The hydrostatic pressure and thus the volume flow are too high. The targeted temperature is reached, only when the water level drops and the hydrostatic pressure drops.

On the other hand, water reaches the targeted temperature at substantially constant hydrostatic pressure already at the beginning of the measurement period of curve K2.

As a result of the earlier higher brew temperature of curve K2, sufficiently hot coffee is brewed compared to curve K1. The coffee is hotter and tastes better because the higher temperatures enable the aroma to develop earlier and thus to a fuller extent.

Furthermore, coffee can also be poured hotter into the pot than in the case of fluctuating brew temperature. This difference is illustrated in FIG. 4. The variables have been measured at a drip stop of a filter. Curve K3 shows the temperature profile when the brew temperature is constant and higher. Curve K4 shows the temperature profile in the absence of a water level regulation.

While the invention has been illustrated and described in connection with currently preferred embodiments shown and described in detail, it is not intended to be limited to the details shown since various modifications and structural changes may be made without departing in any way from the spirit and scope of the present invention. The embodiments were chosen and described in order to explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

1. A machine for preparing a hot beverage, comprising:
a water tank including a reservoir containing water to be heated, and a lead container disposed downstream of the reservoir in a flow direction of the water;
a pipe receiving water from the lead container;
a heating unit heating the pipe, thereby partly evaporating water to produce steam for further transport of water; and
control means for maintaining a water level at a desired value in the lead container.

2. The machine of claim 1, wherein the lead container is connected to the atmosphere.

3. The machine of claim 1, wherein the control means includes a valve controlled by a float.

4. The machine of claim 1, wherein the control means includes a throttle to limit a volume flow from the reservoir to the lead container.

5. The machine of claim 1, wherein the lead container is positioned below the reservoir.

6. The machine of claim 1, wherein the reservoir is constructed for incorporation in the water tank in an exchangeable manner.

7. The machine of claim 1, wherein the reservoir has an outlet port which is level with the desired water level in the lead container and closed by water when reaching the desired water level.

8. The machine of claim 7, wherein the reservoir, except for the outlet port, is sealed in a fluid-tight manner against the atmosphere.

9. The machine of claim 7, wherein the reservoir, besides the outlet port, is fluidly connected to the atmosphere.

10. The machine of claim 1, wherein the lead container has an opening for subjecting the lead container to a pressure which is equal to an ambient atmospheric pressure.

11. The machine of claim 1, wherein the reservoir is a water bottle.

12. The machine of claim 1, wherein the water tank has a receptacle for exchangeably holding the reservoir.

13. The machine of claim 12, wherein the receptacle is height-adjustable for influencing a brew temperature.

14. The machine of claim 1, further comprising a throttle insert disposed in a flow path between the lead container and the heating unit to change a volume flow, said throttle insert being constructed for replacement and/or change in position.

15. The machine of claim 1, further comprising a throttle insert disposed in a flow path between the lead container and the heating unit to change a volume flow, said throttle insert being constructed to allow a change in a throughflow cross section or a length of the flow path.

16. The machine of claim 1, wherein the heating unit is a flow heater.

17. The machine of claim 1, for use as a coffee machine.

18. A method of operating a machine for preparing a hot beverage, comprising the steps of:
transferring water from a lead container which forms part of a water tank and is positioned downstream of a reservoir which forms another part of the water tank and is fluidly connectable to the lead container, into a pipe which is heated by a heating unit to partly evaporate water and thereby produce steam by which water can be further transported; and
maintaining a water level at a desired value in the lead container to maintain a brew temperature constant.

19. The method of claim 18, further comprising the steps of holding the reservoir in a height-adjustable receptacle, and setting the brew temperature by adjusting a height of the receptacle to adjust the desired value for the water level.
